(19) United States
(12) Patent Application Publication
(10) Pub. No.: US 2008/0073512 A1
(43) Pub. Date: Mar. 27, 2008

(54) METHODS, COMPOSITIONS AND DEVICES FOR PERFORMING IONIZATION DESORPTION ON SILICON DERIVATIVES

(75) Inventors: Gary Siuzdak, San Diego, CA (US); Eden Go, San Diego, CA (US); Zhouxin Shen, San Diego, CA (US); Bruce Compton, Lexington, MA (US); Edouard S.P. Bouvier, Stow, MA (US); Grace Credo, Foster City, CA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/829,170

(22) Filed: Jul. 27, 2007

Related U.S. Application Data
(63) Continuation-in-part of application No. 11/288,590, filed on Nov. 29, 2005.
Application No. 11/288,590 is a continuation of application No. PCT/US04/17853, filed on Jun. 4, 2004.
(60) Provisional application No. 60/476,762, filed on Jun. 6, 2003.
(60) Provisional application No. 60/556,984, filed on Mar. 26, 2004.

(51) Int. Cl. C01B 33/113; C07F 7/02; H01J 49/16

(52) U.S. Cl. 250/288; 423/325; 556/400

(57) ABSTRACT

Embodiments of the present invention are directed to a substrate for performing ionization desorption on porous silicon, methods for performing such ionization desorption and methods of making substrates. One embodiment directed to a substrate for performing ionization desorption on silicon comprises a substrate having a surface having a formula of: 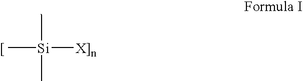
As used above, X is H or Y, where at least at least twenty five mole percent of X is Y and Y is hydroxyl, or —O—R₁, or O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives. The letter “n” represents an integer from 1 to infinity and any vacant valences are silicon atoms, hydrogen or impurities.

### CROSS REFERENCE TO RELATED APPLICATIONS

This application is a Continuation-In-Part of application Ser. No. 11/288,590, filed Nov. 29, 2005, which is a continuation of International Application No. PCT/US04/017853, filed Jun. 4, 2004, Attorney docket number AE-352 and designating the United States, which claims benefit of and priority to U.S. Provisional application No. 60/476,762, filed Jun. 6, 2003, Attorney docket number WAA-352 and U.S. Provisional Application No. 60/556,984, filed Mar. 26, 2004, Attorney docket number AE-390. The entire contents of all applications are hereby expressly incorporated herein by reference in their entirety.

### STATEMENT ON FEDERALLY SPONSORED RESEARCH

Not Applicable

### FIELD OF THE INVENTION

Embodiments of the present invention are directed to substrates of silicon used for performing ionization desorption. These substrates are used in laser equipped mass spectroscopy instruments. Substrates of the present invention provide consistent results after repeated use.

### BACKGROUND OF THE INVENTION

Substrates of porous silicon are used with laser equipped mass spectrometers to perform analyses of samples. The substrate is in the form of a chip having dimensions of approximately three to five centimeters and a thickness of 0.5 millimeter. Sample, generally in the form of an aqueous solution in which one or more compounds are dissolved, is received on the substrate. The substrate is placed in a holder in close proximity to the inlet of a mass spectrometer. A laser pulse is directed to the sample and a portion of the sample is ionized and vaporized from the surface of the substrate by the laser.

As used herein, the term “vaporized” means rendered into a gaseous state. The term “ionized means” having a positive or negative charge.

A further portion of the ionized sample is received by the mass analyzer, for example a time of flight (TOF) mass spectrometer. The mass spectrometer provides information as to the mass and charge of the ionized molecules that comprise the sample. This process, the equipment and the substrates are described in U.S. Pat. No. 6,288,390.

As used herein, the term “DIOS” refers to desorption ionization on silicon and the determination of mass and charge information of ions formed by laser ionization. Such mass and charge information is typically in the form of a mass to charge ratio.

Substrates of porous silicon have a silicon hydride surface. These silicon hydride surfaces oxidize over time. This change in the surface chemistry effects the ionization and vaporization process. Results from the mass spectrometer with the same substrate shift over time due to the change in the surface chemistry.

A more stable surface chemistry would provide greater sensitivity in DIOS processes.

### SUMMARY OF THE INVENTION

Embodiments of the present invention are directed to a substrate for performing ionization desorption on porous silicon, methods for performing such ionization desorption and methods of making substrates. One embodiment directed to a substrate for performing ionization desorption on silicon comprises a substrate having a surface having a formula of: 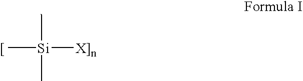
As used above, X is H or Y, where at least at least twenty five mole percent of X is Y and Y is hydroxyl, or —O—R₁ or O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives. The letter “n” represents an integer from 1 to infinity and any vacant valences are silicon atoms, hydrogen or impurities.

Substrates having a surface as described above are resistant to further oxidation reactions. Thus, such substrates provide consistent results over time and repeated ionization events.

Preferably, the mole percent is twenty five to fifty, and more preferably forty to fifty.

In one preferred embodiment, Y is hydroxyl. In a further preferred embodiment, Y is hydroxyl and some portion of Y is represented by the Formula II below:

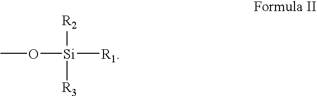

And, even more preferred, R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives. Where Y is represented by the Formula II, the mole percent of Formula II is preferably two to fifty. However, steric concerns generally limit the mole percent of Formula II compositions to six to ten.

Preferably, the methyl, alkyl or aryl hydrocarbons are hydroxyl, amino, amide, carboxyl, ester, carbonyl, sulfhydryl, sulfonyl, phosphoral, bromo, iodo, chloro and fluoro derivatives which when reacted with the silane substrate are water wettable and retentive to proteins, nucleic acids and other molecules of biological origin. Typical water wettable and retentive derivatives exhibit a contact angle of less than 90 degrees.

A further embodiment of the present invention is directed to a method of making a substrate for performing ionization desorption on porous silicon. The method comprised the steps of providing a surface comprising silicon hydride on a porous silicon substrate. At least five mole percent of the silicon hydride is reacted with oxygen to form a silicon oxide.

Preferably, the oxygen is a reactive form such as ozone.

Preferably, the silicon oxide is reacted with a compound represented by the formula WY, wherein W is selected from the group consisting of halogens, methoxy, or ethoxy, and Y is represented by formula:

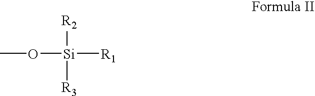

The letters R₁, R₂, and R₃ are used in the same sense as described above. One preferred compound represented by the formula WY is trimethylchlorosilane, pentafluorophenylpropyldimethylchlorosilane and (tridecafluoro-1,1,2,2-tetrahydrooctyl)dimethylchlorosilane, N,O-bis-(trimethylsilyl)trifluoroacetamide (BSTFA); N-methyl-N-trimethylsilylfluoroacetamide (STFA); Hexamethyldisilazane (HMDS); Octyldimethylchlorosilane (ODMCS); Chloro(dimethyl)octadecylsilane (CDOS); Pentafluorophenylpropyldimethylchlorosilane (PFPPDCS); (3,3,4,4,5,5,6,6,6-nonafluorohexyl)chlorosilane (FHCS); Dimethyl-(3,3,3-trifluoropropyl)chlorosilane; Pentafluorophenyldimethylchlorosilane; (3,3,3-Trifluoropropyl)dichloromethylsilane; 4-(2-(trichlorosilyl)ethylpyridine; Vinylphenylmethylchlorosilane; Diphenylmethylethoxysilane; 3-Aminopropyldimethylethoxysilane; (Tridecafluoro-1,1,2,2-tetrahydrooctyl)dimethylchlorosilane; Triphenylchlorosilane; (3,3,3-Trifluoropropyl)dimethylchlorosilane; Bromophenyltrichlorosilane (BP-TCS); and ((Chloromethyl)phenylethyl)trichlorosilane (CMPE-TCS).

A further embodiments of the present invention is directed to a method of performing laser desorption ionization on porous silicon. The method comprises the steps of providing a sample on a porous silicon surface having a formula of: 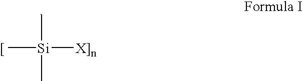
wherein X and the letter “n” are as described above.

Substrates having a surface as described above are resistant to further oxidation reactions. Thus, such substrates provide consistent results over time and repeated ionization events. The surfaces can also be derivatized to provide selectivity in adsorption. For example, where the modification of the surface has functions of cationic exchange, basic compounds within the sample applied to the surface may be selectively retained. Indeed, one embodiment of the present invention is a method of using substrates having a derivatized surface to be water wettable and retentive. Liquid samples spotted to the substrate surface can be withdrawn leaving the compounds of interest on the surface and removing other extraneous compounds that may interfere with further analysis.

These advantages and features, as well as others, are further depicted in the drawings and detailed discussion which follow.

### BRIEF DESCRIPTION OF THE DRAWINGS

FIG. 1 depicts a substrate for performing desorption ionization on silicon having features of the present invention.

FIG. 2 depicts a mass spectrometer equipped with a laser for performing desorption ionization on a silicon substrate employing features of the present invention.

FIG. 3 depicts dried spots and the corresponding mass spectra.

FIG. 4 the mass spectra of procainamide captured on a derivatized substrate surface.

FIG. 5 depicts the mass spectra of des-Arg-Bradykinin captured on a derivatized substrate surface.

FIG. 6 depicts the mass spectra of a mixed sample captures on a derivatized substrate surface.

FIG. 7 depicts the mass spectra of a mixed sample captures on a derivatized substrate surface.

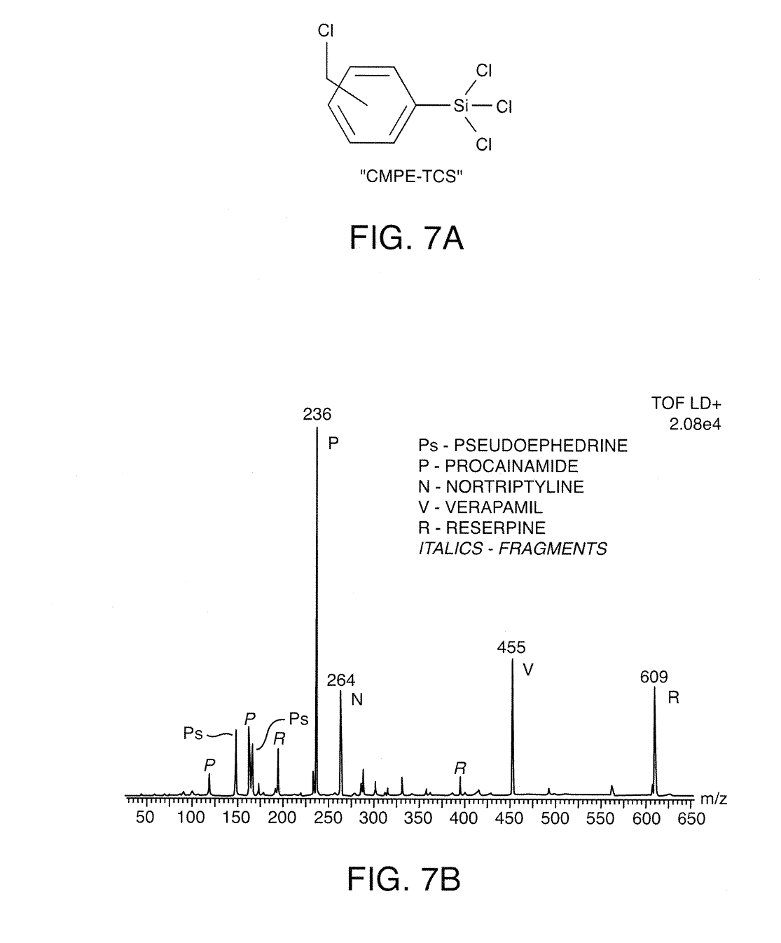

### DETAILED DESCRIPTION OF THE INVENTION

The present invention will be described in detail as a substrate for performing ionization desorption on porous silicon, methods for performing such ionization desorption and methods of making substrates. Embodiments of the present invention will be described with respect to a system in which sample is ionized and vaporized for use in a mass analyzer. However, those skilled in the art will readily recognize that the present invention has utility for all applications in which a sample is ionized and vaporized.

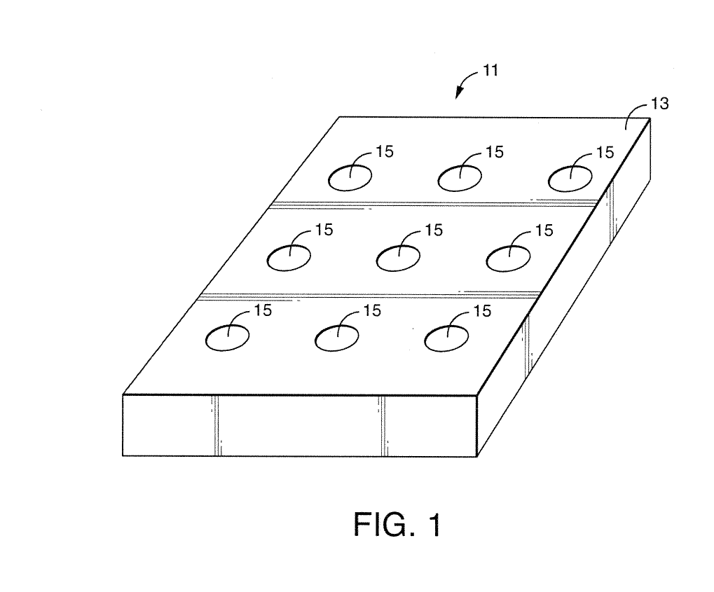

One embodiment directed to a substrate for performing ionization desorption on silicon. A substrate embodying features of the present invention, generally designated by the numeral 11, is depicted in FIG. 1. The substrate is typically rectangular or square in shape, having dimensions of approximately three to four centimeters in length, four to five centimeters in width and one half millimeter in depth. These dimensions and the shape of the substrate are not critical for the function of the substrate but reflect current manufacturing and application preferences. It is common to make such substrates 11 with dimensions to cooperate with holders and other laboratory devices, such as 96 well devices.

The substrate 11 has a surface 13 which extends around the article. However, the features of the present invention are most concerned with the working surface upon which ionization events will occur. Surface 13 has samples identified by the numeral 15 denoting the working surface of the substrate 11. Surface 13 is porous to facilitate retention of the sample 15. Methods of creating a porous silicon surface, are known in the art, for examples, as taught in U.S. Pat. No. 6,288,390. Such surfaces are normally created by laser etching a silicon surface.

Substrate 11 has an interior mass having a silicon composition. The surface 13 has a composition reflecting the termination of the silicon mass. The surface 13 has a composition represented by the formula:

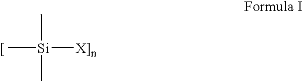

As used above, X is H or Y, where at least at least twenty five mole percent of X is Y and Y is hydroxyl, or —O—R₁ or —O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives. The letter “n” represents an integer from 1 to infinity and any vacant valences are silicon atoms, hydrogen or impurities.

Substrates 11 having a surface 13 as described above are resistant to further oxidation reactions. Thus, such substrates 11 provide consistent results over time and repeated ionization events. For example, substrates for performing desorption ionization are routinely used repeatedly. Substrates with a hydride surface chemistry react in response to energy received in the ionization process, the sample, and the atmosphere. These changes in surface chemistry alter the manner in which a further sample will respond to further ionization events. The results from subsequent ionization events differ from early ionization events, which is undesirable.

For greater consistency in results, the mole percent is twenty five to fifty, and more preferably forty to fifty.

In one preferred embodiment, Y is hydroxyl. In a further preferred embodiment, at least a portion of Y is represented by the Formula II below:

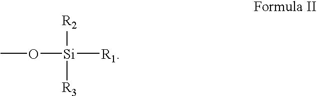

And, even more preferred, R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives. And, even more preferred, R₁, R₂, and R₃ are methyl. Due to steric hindrance the mole percent of Formula II compositions is preferably at least two, and more preferably, six to ten.

A further embodiment of the present invention is directed to a method of making a substrate for performing ionization desorption on porous silicon. The method comprised the steps of providing a surface comprising silicon hydride on a porous silicon substrate. At least five mole percent of the silicon hydride is reacted with oxygen to form a silicon oxide.

Preferably, the oxygen in a reactive form such as ozone. Methods for reacting silicon surfaces with ozone are known in the art. The silicon surfaces are exposed to an atmosphere of concentrated ozone and allowed to react to form a silicon oxide.

Preferably, the silicon oxide is reacted with a compound represented by the formula WY, wherein W is selected from the group consisting of halogens, methoxy, or ethoxy, and Y is represented by formula:

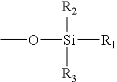

The letters R₁, R₂, and R₃ are used in the same sense as described above. The compound represented by WY, may comprise any organosilane. One preferred compound represented by the formula WY is trimethylchlorosilane. A further preferred compound is aminopropyldimethylethoxysilane.

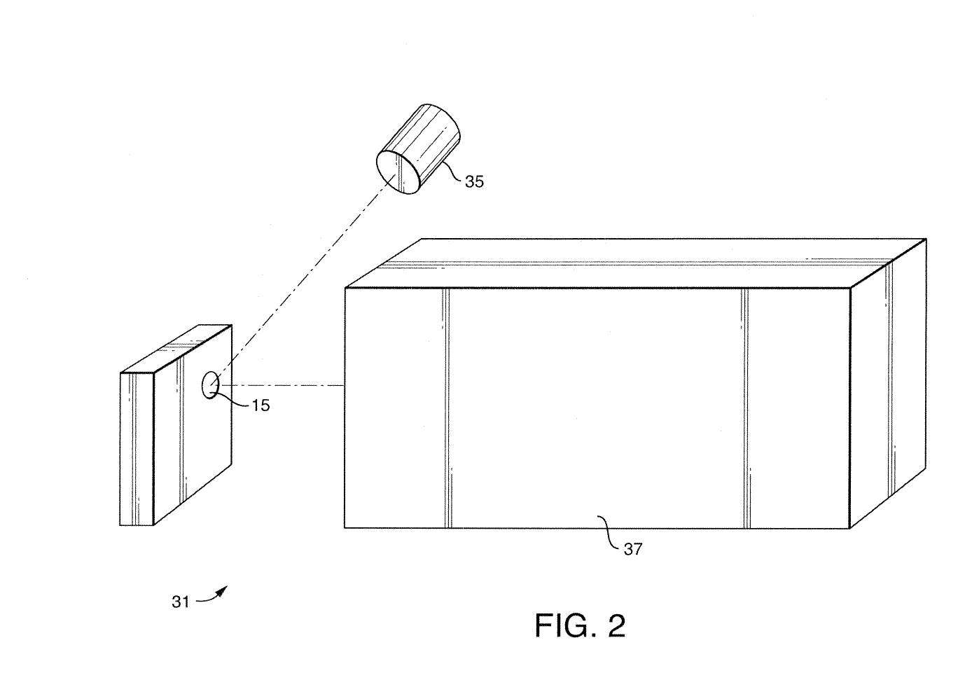

A further embodiments of the present invention is directed to a method of performing laser desorption ionization on porous silicon. The method will be described with respect to the apparatus depicted in FIG. 2. An apparatus for performing laser desorption ionization on porous silicon, generally designated by the numeral 31, has the following major elements: a porous substrate 11, a laser 35, and a mass spectrometer 37.

Porous substrate 11 is held in alignment with laser 35 by means of a holder (not shown) of standard known configuration. The porous substrate 11 is positioned in close proximity to the inlet (not shown) of mass spectrometer 37.

Mass spectrometer 37 of the commonly of the time of flight type, of known configuration. And, therefore, mass spectrometer 37 is not depicted in detail.

A sample 15 is placed on the porous silicon surface 13 of substrate 11. The porous silicon surface 13 has a surface chemistry having a formula of: 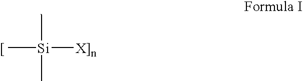
wherein X and the letter “n” are as described above.

Laser 35 is discharged or pulsed ionizing and vaporizing a portion of the sample 15. Vapor, ions and gases are drawn into the inlet of the mass spectrometer 37 for analysis. Mass spectrometer 37 provides mass and charge information, such as the mass to charge ratio, as to ions received.

Substrates 11 having a surface 13 as described above are resistant to further oxidation reactions. Thus, such substrates provide consistent results over time and repeated ionization events.

### EXAMPLE 1

The silicon oxide surface of a substrate was reacted with trimethylchlorosilane, and then washed with neat isopropanol. A sample of bovine serum albumin (BSA) digest was applied to the surface and analyzed using a matrix assisted laser desorption ionization mass spectrometer (MALDI-MS) instrument. 500 amol could be detected, at a concentration comparable to that detected by DIOS-MS from a silicon hydride surface. DIOS-MS was performed on the trimethylsilane (TMS)-derivatized surface over the course of several weeks, and no reduction in signal intensity was observed over that time. In contrast, an underivatized DIOS surface shows significant signal deterioration after 2-3 weeks.

### EXAMPLE 2

The silicon oxide surface was reacted with aminiopropyldimethylethoxysilane. This derivatized surface has been found to provide an enhancement in selectivity for certain compounds. For example, sugars such as sucrose and maltotriose cannot be readily detected by DIOS using silicon hydride surfaces, or TMS-derivatized surfaces. However, the amine-derivatized surface provides several orders of magnitude enhancement in signal. This derivatized surface provides selectivity in adsorption. For example, derivatizing a surface with a cation exchanger would selectively bind basic compounds, and would enable easy removal of neutrals and acid interferences. One example demonstrated with TMS-derivatized surfaces is that peptide digests in a solution of 8M urea can be loaded onto a chip, and the peptide will strongly adsorb to the surface. The non-binding urea can then be easily removed prior to mass spec analysis. A fourth benefit of this derivatization technique is that it provides for a simple means to alter the physical properties of the surface. For example, an amine-derivatized surface will provide a much higher surface tension (contact angle is solvent dependent) than silicon hydride or TMS derivatized surface. By patterning the surface with one or more silane reactants, the surface hydrophobicity can be selectively altered to help position and/or concentrate a sample of the surface.

### EXAMPLE 3

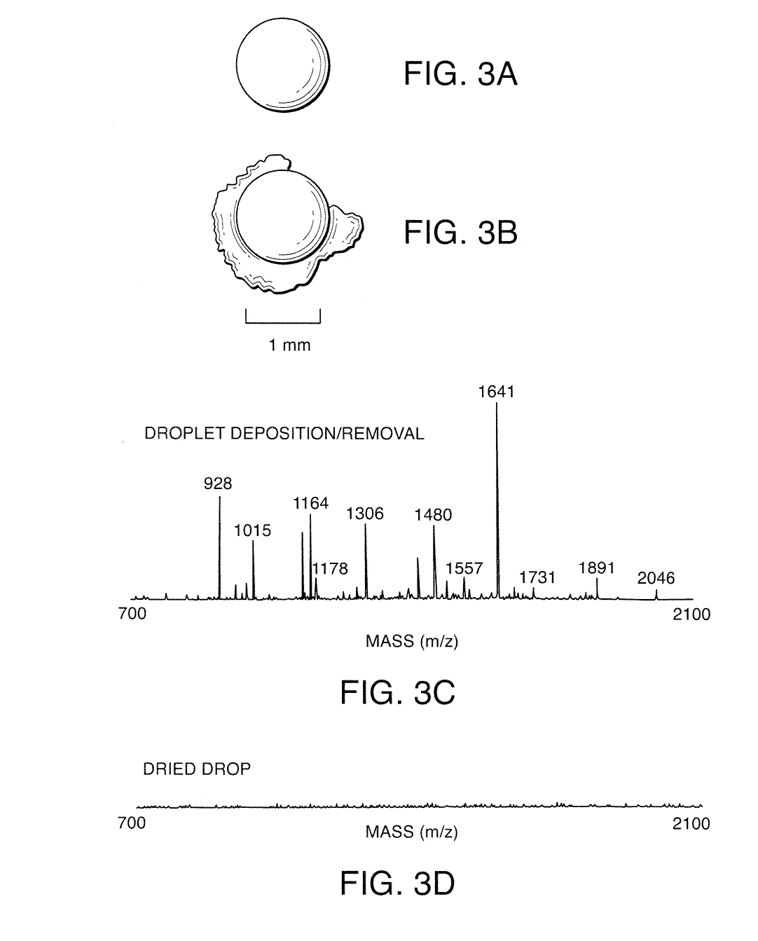

Peptide digest: DIOS chips were prepared by etching low resistivity (0.005-0.02 Ω-cm) n-type Si(100) wafers (Silicon Sense) in 25% v/v HF/ethanol under white light illumination at a current density of 5 mA/cm² for 2 minutes. Photopatterning was performed to create 100 sample spots on each chip. Immediately after etching, the DIOS chip was rinsed with ethanol and dried in a stream of N₂ to give an H-terminated surface, which was oxidized by exposure to ozone (flow rate of 0.5 g/h from an ozone generator directed at the surface for 30 seconds). The silylation reaction was performed by adding 15 μL of neat pentafluorophenylpropyldimethylchlorosilane on the oxidized DIOS chip, placing the chip in a glass Petri dish, and incubating in an oven at 65° C. for 15 minutes. The modified DIOS chip was then rinsed thoroughly with methanol and was dried in a stream of N₂. 0.5 μL of sample containing bovine serum albumen (BSA) tryptic digest in 8 M urea was spotted with a pipette. The liquid was removed by aspiration with the same pipette. Samples were analyzed using a MALDI instrument. Excellent signal for the BSA digest was observed. However, in the case where the liquid was allowed to dry on the target surface with the BSA digest, no analyte signal was observed. FIG. 3 shows the resulting dried spots and corresponding MALDI mass spectra obtained for both cases.

### EXAMPLE 4

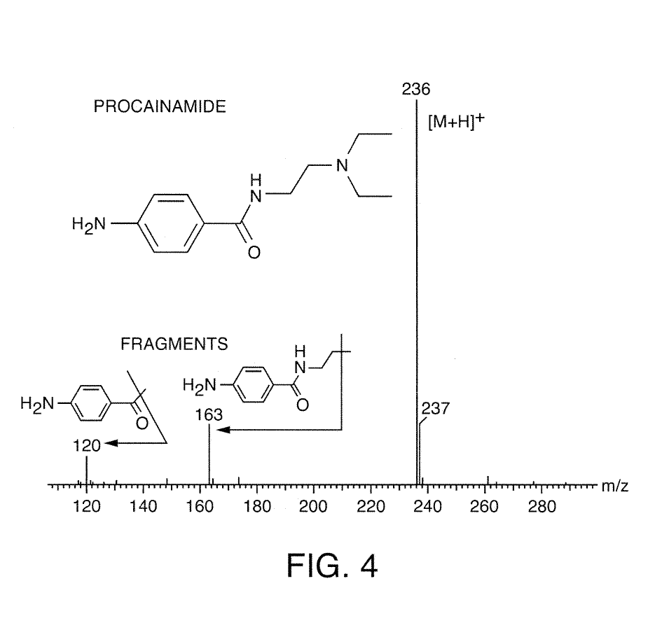

Small molecule: A silicon wafer (0.08 to 0.20 ohm-cm, Sb-doped, n-type, SiliconQuest, Santa Clara, Calif.) was prepared by rinsing in ethanol and immersing in aqueous 5% hydrofluoric acid (HF). It was rinsed in ethanol again and then dried. The silicon wafer was patterned using a custom mask during a light-assisted electrochemical etch in ethanolic 25% HF for 2 min. at 6 mA constant current and 50 mW/cm2. After etching it was rinsed in ethanol again and dried. It was then oxidized by exposure to ozone gas flow and immersed in aqueous 5% HF. The substrate was then rinsed in ethanol again and dried. It was then placed in a glass petri dish as neat pentafluorophenylpropyldimethylchlorosilane was added so that it just covered the surface. The petri dish was covered and sat on a hot plate set at 90° C. for 15 min. After rinsing the chip with ethanol and drying with N₂, 0.5 uL of procainamide dissolved in DMSO was spotted with a pipette. The liquid was removed by aspiration using the same pipette. Samples were analyzed using a MALDI instrument. Excellent signal for procainamide was observed, as well as some procainamide fragments. See FIG. 4.

### EXAMPLE 5

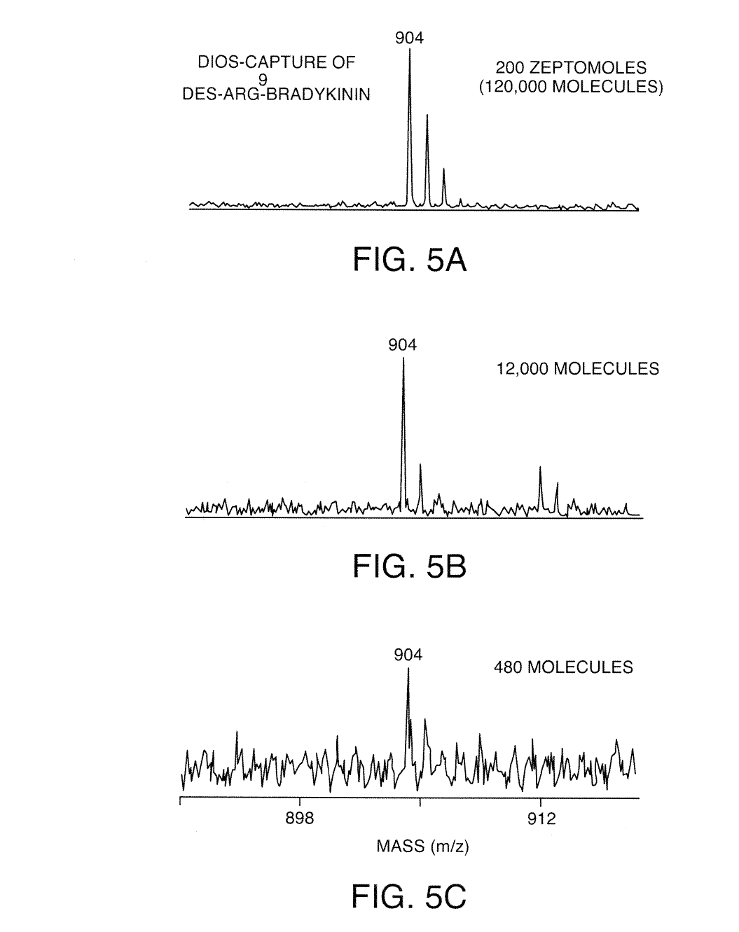

Peptide, high sensitivity. DIOS chips were prepared by etching low resistivity (0.005-0.02 Ω-cm) n-type Si(100) wafers (Silicon Sense) in 25% v/v HF/ethanol under white light illumination at a current density of 5 mA/cm² for 2 minutes. Photopatterning was performed to create 100 sample spots on each chip. Immediately after etching, the DIOS chip was rinsed with ethanol and dried in a stream of N₂ to give an H-terminated surface, which was oxidized by exposure to ozone (flow rate of 0.5 g/h from an ozone generator directed at the surface for 30 seconds) and subsequently modified with (tridecafluoro-1,1,2,2-tetrahydrooctyl)dimethylchlorosilane. The silylation reaction was performed by adding 15 μL of neat (tridecafluoro-1,1,2,2-tetrahydrooctyl)dimethylchlorosilane on the oxidized DIOS chip, placing the chip in a glass Petri dish, and incubating in an oven at 65° C. for 15 minutes. The modified DIOS chip was then rinsed thoroughly with methanol and was dried in a stream of N₂. An 0.2 μL droplet of Des-Arg⁹-Bradykinin was spotted onto the DIOS substrate at different concentrations, resulting in deposition of 200 zeptomole, 20 zeptomole and 800 yoctomole. FIG. 5 shows the resulting mass spectra obtained using MALDI instrumentation. Sensitivity obtained is six orders of magnitude better than the first publication of DIOS-MS (J. Wei et al., “Desorption-ionization mass spectrometry on porous silicon”, Nature 399, 243-246, 1999).

### EXAMPLE 6

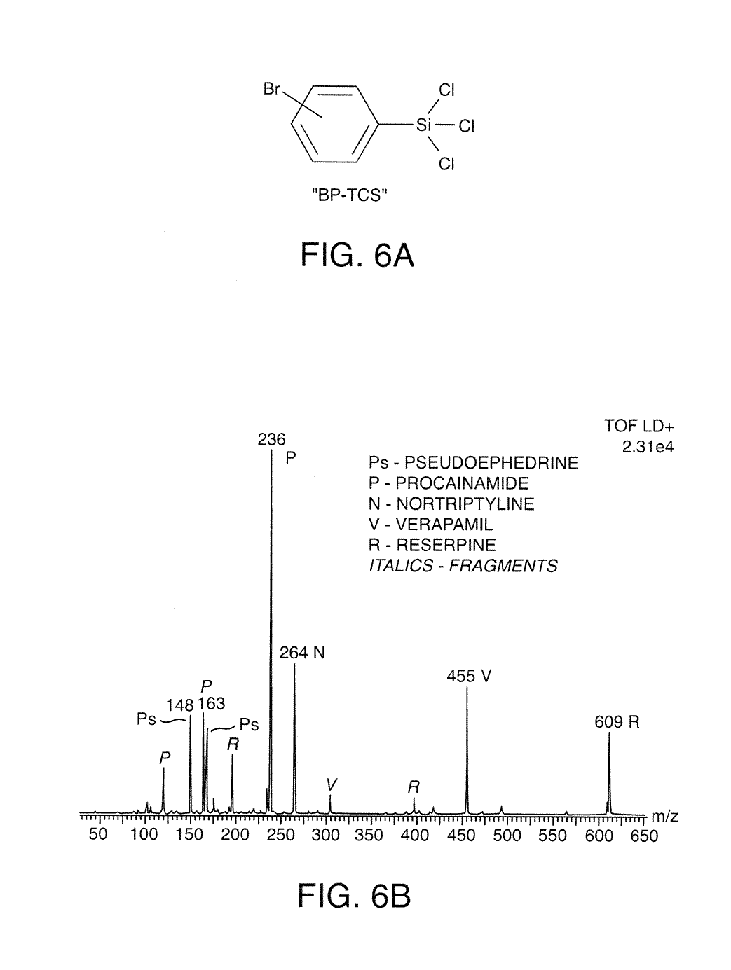

A silicon wafer (0.08 to 0.20 ohm-cm, Sb-doped, n-type; SiliconQuest Santa Clara, Calif.) was prepared by rinsing in ethanol and immersing in aqueous 5% hydrofluoric acid (HF). It was rinsed in ethanol again and then dried. The silicon wafer was patterned using a custom mask during a light-assisted electrochemical etch in ethanolic 25% HF for 2 min. at 6 mA constant current and 50 mW/cm². After etching it was rinsed in ethanol again and dried with N₂. It was then oxidized by exposure to ozone gas flow and immersed in aqueous 5% HF. The substrate was then rinsed in ethanol again and dried with N₂. For derivatization, the dried wafer was exposed to ozone again. It was then placed in a glass petri dish where neat derivatization agent was added directly to the surface so that it just covered the surface. The petri dish was covered and was placed on a hot plate set at 90° C. for 15 min. In FIG. 6, Bromophenyltrichlorosilane (BP-TCS) was used to derivatize a DIOS-target plate. A solution containing pseudoephedrine, procainamide, nortriptyline, verapamil, and reserpine was spotted onto the derivatized DIOS substrate and detected with the MALDI mass spectrometer. In FIG. 5, ((Chloromethyl)phenylethyl)trichlorosilane (CMPE-TCS) was used to derivatize a DIOS-target plate. The same solution containing the five compounds was spotted onto this DIOS-target plate, and analyzed by MALDI-MS.

In another embodiment, surface modification can be made on silicon particles, particularly those less than about 10 nm in diameter, but not limited to. Alternatively, surface modification can be made on silicon nanofibers, which have characteristic diameters of less than 100 nm, but can be several microns in length. These nanoparticles are then attached to a conductive surface. One method is to use a conductive thermoplastic, such as carbon-impregnated polypropylene. The particles are attached to the surface after heating the polypropylene above the glass transition temperature (T_{g}). Alternatively, silicon fibers can be grown directly off of a conductive surface.

We have found that the pentafluorophenylpropyldimethylchlorosilane and (tridecafluoro-1,1,2,2-tetrahydrooctyl)dimethylchlorosilane gave the best results for DIOS-MS. These reagents provides very low background signal and highest sensitivity observed to-date. In addition, lower laser energies are required with these-surfaces than other surfaces that were evaluated. However, a number of other reagents can be used for surface modification. Preferred silanes are halogenated, alkyl or aryl. Silanes that we have evaluated to-date are: N,O-bis-(trimethylsilyl)trifluoroacetamide (BSTFA); N-methyl-N-trimethylsilylfluoroacetamide (MSTFA); Hexamethyldisilazane (HMDS); Octyldimethylchlorosilane (ODMCS); Chloro(dimethyl)octadecylsilane (CDOS); Pentafluorophenylpropyldimethylchlorosilane (PFPPDCS); (3,3,4,4,5,5,6,6,6-nonafluorohexyl)chlorosilane (FHCS); Dimethyl-(3,3,3-trifluoropropyl)chlorosilane; Pentafluorophenyldimethylchlorosilane; (3,3,3-Trifluoropropyl)dichloromethylsilane; 4-(2-(trichlorosilyl)ethylpyridine; Vinylphenylmethylchlorosilane; Diphenylmethylethoxysilane; 3-Aminopropyldimethylethoxysilane; (Tridecafluoro-1,1,2,2-tetrahydrooctyl)dimethylchlorosilane; Triphenylchlorosilane; (3,3,3-Trifluoropropyl)dimethylchlorosilane; Bromophenyltrichlorosilane (BP-TCS); and ((Chloromethyl)phenylethyl)trichlorosilane (CMPE-TCS).

Preferred silanes result in providing a hydrophobic surface, where the contact angle of water on the surface is greater than 90°. In another preferred embodiment, a silane or mixture of silanes is chosen to provide a water-wettable surface capable of adsorbing analyte. In this case, the contact angle of water on the surface is less than 90°.

This technique can be used with or without a MALDI matrix. The matrix is typically an aromatic organic acid, such as 4-hydroxy-α-cyanocinnamic acid or 2,5-dihydroxybenzoic acid. When performing MALDI, sample solution is applied to the target substrate without the matrix. After removal of liquid, a solution of matrix is applied. As the solvent evaporates, the analyte becomes incorporated into the matrix crystals that form.

The analyte capture/laser desorption mass spectrometry technique is influenced by the following considerations: (1) the analyte adsorbs onto the surface of the substrate, (2) the surface area is great enough to provide a high phase ratio of adsorptive sites; this enables greater mass of analyte to adsorb to the surface, (3) the surface is sufficiently clean to minimize background interference, (5) the surface modification does not self-fragment or cause other interferences that would lead to high levels of background and/or detrimental ion suppression.

What is claimed:

1. A substrate for performing ionization desorption on silicon comprising a substrate having a formula of: 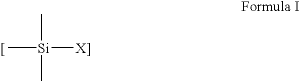
wherein X is H or Y, where at least at least twenty five mole percent of X is Y and Y is hydroxyl, or —O—R₁ or O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives.

2. The article of manufacture of claim 1 wherein Y is hydroxyl.

3. The article of manufacture of claim 1 wherein said mole percent is twenty-five to fifty.

4. The article of manufacture of claim 1 wherein at least a portion of Y is represented by the Formula II below: 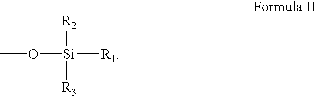
wherein R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives.

5. The article of manufacture of claim 4 wherein R₁, R₂, and R₃ are methyl or alkyl carbon chains of less than or equal to eighteen carbons.

6. A method of making a substrate for performing ionization desorption on silicon, comprising the steps of providing a surface comprising silicon hydride on said substrate, reacting at least five mole percent of the silicon hydride with oxygen to form a silicon oxide.

7. The method of claim 6 further comprising reacting said silicon oxide with a compound represented by the formula WY, wherein W is selected from the group consisting of halogens, methoxy, or ethoxy, and Y is represented by formula: 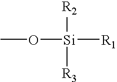
wherein R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives.

8. The method of claim 7 wherein said compound represented by the formula WY is trimethylchlorosilane.

9. The method of claim 7 wherein said compound represented by the formula WY is amino propyldimethylethoxysilane.

10. A method of performing laser desorption ionization on silicon comprising the steps of providing a sample on a porous silicon surface having a formula of: 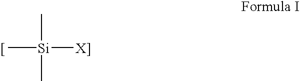
wherein X is H or Y, where at least at least twenty five mole percent of X is Y and Y is hydroxyl, or —O—R₁ or O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives, ionizing at least a portion of said sample by means of a laser to form an ionized sample, placing said ionized sample in mass spectrometer means for a determination of a mass charge relationship.

12. The method of claim 11 wherein said sample is provided on said substrate and withdrawn to leave a residue having compounds of interest laser ionization.

13. The article of manufacture of claim 10 wherein Y is hydroxyl.

14. The article of manufacture of claim 10 wherein said mole percent is twenty five to fifty.

15. The article of manufacture of claim 10 wherein at least a portion of Y is represented by the Formula II below: 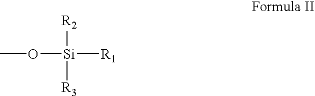
wherein R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives.

16. The article of manufacture of claim 13 wherein R₁, R₂, and R₃ are methyl or alkyl carbon chains of less than or equal to eighteen carbons.

17. An apparatus for performing laser desorption ionization mass analysis comprising:
a substrate having a porous silicon surface having a formula of: 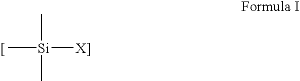
wherein X is H or Y, where at least at least twenty five mole percent of X is Y and Y is hydroxyl, or —O—R₁ or O—SiR₁, R₂, R₃ wherein R₁, R₂, and R₃ are selected from the group consisting of alkyl, alkenyl, alkynyl, aromatic, amino alkyl, amino alkenyl, amino alkynyl, pyridinyl, pyrridonyl, and carbonyl, alcohol and carboxylic acid derivatives thereof having one to twenty five atoms, and hydroxyl, amino, amide, carboxyl, ester, carbonyl, sulfhydryl, sulfonyl, phosphoral, bromo, iodo, chloro and fluoro derivatives,
a laser aligned with said substrate to pulse light energy on said sample to ionize and vaporize a portion of said sample, to form a ionized sample, and
a mass analyser for receiving said ionized sample for a determination of a mass charge relationship.

18. The apparatus of claim 14 wherein said Y is represented by the Formula II below: 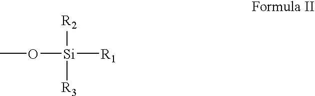
wherein R₁, R₂, and R₃ are methyl or alkyl carbon chains of less than or equal to eighteen carbons or single and poly-aromatic hydrocarbons and their hydroxyl, amino, amide, carboxyl, ester, carbonyl, sulfhydryl, sulfonyl, phosphoral, bromo, iodo, chloro and fluoro derivatives and, Y represented by Formula II has a mole percent of two to ten.
